(19) United States
(12) Patent Application Publication
(10) Pub. No.: US 2012/0292582 A1
(43) Pub. Date: Nov. 22, 2012

(54) AMMONIUM SALTS OF 9,10-DIHYDRO-10-HYDROXY-9-OXA-10-PHOSPHA-PHENANTHRENE-10-ONE

(75) Inventors: Thomas Zich, Linz (AT); Fritz Freidl, Krems (AT); Bernadette Mehofer, Krems (AT); Michael Hönel, Graz (AT); Johannes Artner, Wien (AT); Manfred Döring, Worth am Rhein (DE); Michael Ciesielski, Merseburg (DE)

(73) Assignee: Krems Chemie Chemical Services AG, Krems (AT)

(21) Appl. No.: 13/448,479

(22) Filed: Apr. 17, 2012

(30) Foreign Application Priority Data
Apr. 18, 2011 (AT) AT A548/2011

(51) Int. Cl. C07F 9/6571; C09K 21/14; C07F 9/38; C09K 21/12; B82Y 30/00

(52) U.S. Cl. 252/609; 558/82; 562/23; 544/195; 977/773

(57) ABSTRACT

The invention relates to ammonium salts of 9,10-dihydro-10-hydroxy-9-oxa-10-phosphaphenanthrene-10-one or -10-oxide (DOPO-OH) of formula I:

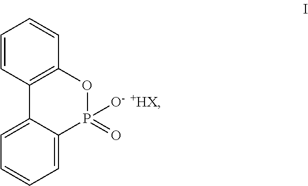

wherein X is selected from ammonia, melamine, and guanidine, as well as ring-opened hydrolyzates thereof according to the following formula II:

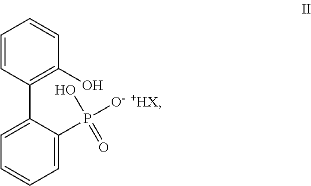

wherein X is defined as above.

The present invention relates to new ammonium salts of 9,10-dihydro-10-hydroxy-9-oxa-10-phosphaphenanthrene-10-one or -10-oxide (DOPO-OH), methods for the preparation thereof, and their use as a flame retardants.

From the literature it is known that 9,10-dihydro-9-oxa-10-phosphaphenanthrene-10-one or -oxide (DOPO), which was first described by Sanko Chemical Co. Ltd. in DE 20 34 887, and various derivatives thereof have good flame-retardant properties, wherein this effect seems to be based on the fact that these compounds release phosphorus-containing free radicals when heated (see e.g. Schaefer et al., J. Appl. Polym. Sci. 105(2), 685-696 (2007)).

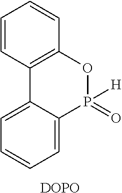

Also known is the oxidation product DOPO-OH. Its production has, for example, been described by J. Cadogan (J. Cadogan, J. Chem. Soc. Chem. Commun. 23, 1685 (1986)) and by A. Schäfer (A. Schäfer, Diss., Ruprecht-Karls-Universitat, Heidelberg, Germany, 2008).

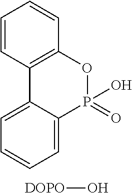

The present inventors have disclosed a number of sulfur-containing derivatives in the Austrian patent applications AT 508,468 A1 and AT A 570/2010 and in WO 2011/000019 based thereon, which also have good flame-retardant properties. Specifically, derivatives of 9,10-dihydro-9-oxa-10-phosphaphenanthrene-10-thione or -10-sulfide (DOPS) were produced.

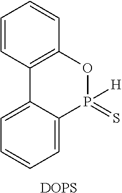

These also included DOPS-OH, DOPS-SH, as well as various ammonium salts of both.

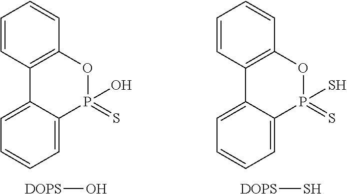

In addition, the inventors have discovered that such sulfur derivatives show a synergistic effect with elemental sulfur and other sulfur-containing compounds. This synergy has proven to be extremely substance-specific, i.e. not every sulfur-containing compound known to promote flame retardancy shows the same synergistic effect, if any.

Furthermore it is known from the literature that ring-opened hydrolyzates of such substances, i.e. compounds containing the structure

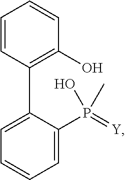

wherein Y is oxygen or sulfur, may also have a flame-retardant effect.

Against this background, it was nevertheless desirable to have further, novel substances with good flame retardancy, especially substances that improve the gas-phase activity and which may be used to endow natural or synthetic polymers with flame retardancy.

It was thus an object of the present invention to provide novel compounds with improved flame-retardant properties. It was especially interesting to find out whether other derivatives of DOPO and DOPO-OH also show synergistic effects with sulfur or sulfur compounds, since the inventors themselves have found that it is not possible to make predictions in this regard, but that this property has to be tested for each novel compound individually.

In WO 2011/035357 A1, Sunpor Kunststoff Ges.m.b.H. describes, especially on page 17, derivatives of DOPO as flame retardants, which also include alkaline and alkaline earth, ammonium and phosphonium salts of DOPO-OH and DOPO-SH. However, none of these salts is actually produced nor are there any instructions for their preparation. The only flame retardant tested is DOPO itself.

### DISCLOSURE OF THE INVENTION

The above object is achieved by providing three novel ammonium salts of DOPO-OH, i.e. ammonium salts of 9,10-dihydro-10-hydroxy-9-oxa-10-phosphaphenanthrene-10-one or -10-oxide (DOPO-OH) of formula I:

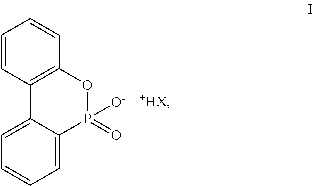

wherein X is selected from ammonia, melamine, and guanidine, as well as ring-opened hydrolyzates thereof according to the following formula II:

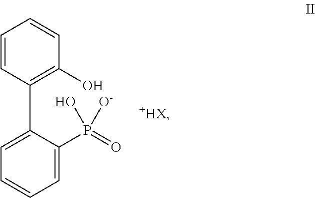

wherein X is defined as above.

This includes especially the following three compounds:
9,10-dihydro-10-hydroxy-9-oxa-10-phosphaphenanthrene-10-one or -10-oxide ammonium salt (DOPO-ONH₄):

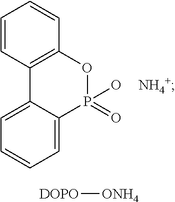

9,10-dihydro-10-hydroxy-9-oxa-10-phosphaphenanthrene-10-one or -10-oxide melaminium salt (DOPO-OMel):

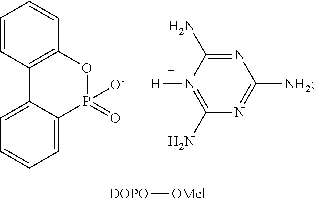

and 9,10-dihydro-10-hydroxy-9-oxa-10-phosphaphenanthrene-10-one or -10-oxide guanidinium salt (DOPO-OGua):

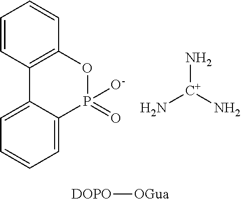

All three of these novel compounds have proven to be effective flame retardants, which may especially be included without producing any odor into polymeric masses to be endowed with flame retardancy, which was not always the case with, for example, substances produced by the inventors in former works. Furthermore, a synergy with sulfur or sulfur-containing substances has been found for all four compounds.

In a second aspect, the invention thus relates to the use of new compounds as flame retardants, alone or in a combination of several thereof, preferably in a proportion of 0.1 to 30 wt %, preferably 3 to 10 wt %, based on the total weight of the substrate to be endowed with flame retardancy and the flame retardant(s).

A new ammonium salt of the invention or a mixture of several thereof is preferably used in combination with elemental sulfur and/or at least one sulfur-containing compound as (a) synergistic flame retardant(s), wherein the at least one sulfur-containing compound has at least one S—S bond and is more preferably selected from ammonium thiosulfate, melamine thiosulfate and alkylphenol polysulfides, e.g. polymeric p-t-butylphenol disulfide, because these show an especially good synergistic effect with the inventive DOPO derivatives.

In a third aspect of the invention, the inventive novel substances can be used as flame retardants in a flame-retardant composition, which, in addition to one or more of the novel compounds, may also include one or more synergists and/or further additives, auxiliaries or co-components conventionally used in the art. In particular, the flame-retardant composition additionally contains elemental sulfur and/or at least one sulfur-containing compound, which is/are preferably selected from ammonium thiosulfate, melamine thiosulfate and alkylphenol polysulfides, e.g. polymeric p-t-butyl-phenol disulfide (e.g. Vultac® TB7), and 2,2′-dibenzothiazolyl disulfide (MTBS).

The optional additives include for example heat stabilizers, light stabilizers, UV absorbers, antioxidants, antistatic agents, preserving agents, acid acceptors, anti-fungal agents, fillers, pigments, colorants, plasticizers, lubricants, wetting agents, anti-dripping agents, nanoparticles, reinforcing material such as glass, carbon, metal or natural fibers, and other flame retardant additives, smoke suppressants and mixtures thereof as conventionally used. Preferably, they are selected from red phosphorus, organic peroxides, metals and metal compounds, nitrogen compounds, nanoparticles and mixtures thereof.

Nitrogen-containing compounds include, for example, ammonium polyphosphate, ammonium hydrogen phosphate, ammonium dihydrogen phosphate; biuret, allantoine, glycolurile, dicyandiamide, guanidine and derivatives thereof; melamine and derivatives thereof, e.g. condensation products of melamine, into homologues (e.g. melam, melem, melon) and/or with polybasic acids such as phosphoric acid, e.g. melamine phosphate or melamine polyphosphate, as well as bi- and trivalent inorganic salts and mixed salts thereof, melamine pyrophosphate, melamine cyanurate; esters, amides, and polycondensation products of cyanuric acid, isocyanuric acid, and guanamine or derivatives thereof.

Further possible additives comprise, for example, aryl and alkyl phosphate esters, metal phosphinates or metal hypophosphites, metal phosphates, metal aminophosphonate, as well as condensation products thereof, members of the Exolite® series, i.e. metal salts of phosphinic acid and diphosphinic acid, metal borates, metal oxides, metal hydroxides such as aluminum or magnesium hydroxides, aluminum trihydrate, boehmite, carbon formers such as pentaerythritol, dipentaerythritol and tripentaerythritol as well as derivatives thereof. Among these, melamine cyanurate, melamine polyphosphate, melamine poly(aluminum phosphates) and poly(zinc phosphates), e.g. those available under the trademark Safire® from Catena Additives, aluminum trihydrate, and boehmite are preferred.

In a fourth aspect, the invention provides methods for producing the novel compound by reacting 9,10-dihydro-10-hydroxy-9-oxa-10-phosphaphenanthrene-10-one or -10-oxide (DOPO-OH) with the corresponding amine or a salt thereof.

Preferably, DOPO-OH is reacted with ammonia to give 9,10-dihydro-10-hydroxy-9-oxa-10-phosphaphenanthrene-10-one or -10-oxide ammonium salt (DOPO-ONH₄), with melamine to give 9,10-dihydro-10-hydroxy-9-oxa-10-phosphaphenanthrene-10-one or -10-oxide melaminium salt (DOPO-OMel) or with guanidinium carbonate to give 9,10-dihydro-10-hydroxy-9-oxa-10-phosphaphenanthrene-10-one or -10-oxide guanidinium salt (DOPO-OGua).

Of course, the inventive novel compounds may also be obtained via other routes, wherein a skilled artisan should—with reference to the particular phosphine chemistry—be able to determine a number of alternative synthetic routes, routes that already start with a DOPO derivative as well as routes where the dihydrooxaphosphaphenanthrene parent substance still has to be formed, e.g. similar to the synthesis based on o-phenylphenol disclosed in DE 20 34 887.

The following examples describe the preferred preparation of the inventive novel substances as well as of the preferred precursor DOPO-OH in detail, and the compounds thus obtained were tested for their flame retardancy. The melting points or decomposition points were measured on a Kofler hot-stage microscope and are uncorrected. All values are averages of several determinations.

### EXAMPLES

### Reference Examples 1 to 3

### Preparation of 9,10-dihydro-10-hydroxy-9-oxa-10-phosphaphenanthrene-10-one or -10-oxide (DOPO-OH)

### Reference Example 1

### Preparation of DOPO-OH in an Aqueous Environment

In a multi-necked flask, equipped with a stirrer, a condenser and a thermometer, 302.6 g of powdered 9,10-dihydro-9-oxa-10-phosphaphenanthrene-10-oxide (DOPO) were suspended in 327.6 g of water, heated to 90° C., and reacted with 190.5 g of 30% hydrogen peroxide at a temperature of 90-99° C. within 6 h. Subsequently, the suspension was cooled to room temperature, the precipitate was filtered off and washed with water. Drying of the filter cake was done at 150° C. The crude yield was 312.2 g [96.1% of theory]. After recrystallization from acetic acid, the following data were obtained:

Mp.: 203° C. (lit.: 203-204° C.; J. Cadogan, supra)

Elemental analysis C₁₂H₉O₃P (M: 232.17 g/mol):

calcd. C, 62.08%; H, 3.91%; P, 13.34

found C, 61.5%; H, 4.2%; P, 13.2

### Reference Example 2

### Preparation of DOPO-OH in an Alcoholic-Aqueous Environment

In a multi-necked flask, equipped with a stirrer, a condenser and a thermometer, 302.6 g of DOPO were pre-dissolved in 200.0 g of methanol at 25° C. and reacted with 317.5 g of 30% hydrogen peroxide within 6 h at a temperature continually raised to 80° C. The resulting suspension was cooled to room temperature, the precipitate was filtered off and washed with methanol. Drying of the filter cake was done at 150° C. The crude yield was 277.1 g [85.3% of theory]. After recrystallization from acetic acid, the following data were obtained:

Mp.: 203° C. (lit.: 203-204° C.); phosphorus content: found 13.3%. calcd. 13.34%.

### Reference Example 3

### Preparation of DOPO-OH in an Aromatic-Aqueous Environment

In a multi-necked flask, equipped with a stirrer, a condenser and a thermometer, 302.6 g of DOPO were dissolved in 150.0 g of toluene at 70° C. and reacted with 204.1 g of 30% hydrogen peroxide within 7 h at a temperature continually raised to 85° C. Subsequently, 183.8 g of the toluene-water mixture were removed by distillation. The residue was cooled to room temperature and filtered off. Drying of the filter cake was done at 150° C. The crude yield was 314.9 g [96.9% of theory]. After recrystallization from acetic acid, the following data were obtained:

Mp.: 202-203° C. (lit.: 203-204° C.); phosphorus content: found 13.2%. calcd. 13.34%.

### Examples 1 to 4

### Preparation of the Novel Compounds of the Invention

### Example 1

### Preparation of 9,10-dihydro-10-hydroxy-9-oxa-10-phosphaphenanthrene-10-one or -10-oxide ammonium salt (DOPO-ONH₄): liquid procedure

In a multi-necked flask, equipped with a stirrer, a condenser and a thermometer, 232.1 g of 9,10-dihydro-10-hydroxy-9-oxa-10-phosphaphenanthrene-10-oxide (DOPO-OH) were suspended in 216.0 g of water and reacted with 71.5 g of 25% ammonia at 25° C. Subsequently, the suspension was heated to 98° C. and then cooled to room temperature. The entire flask content was emptied onto a drying tray and dried at 120° C. The yield was 248.4 g [99.7% of theory] of a white crystalline solid.

Mp.: 234-240° C. (dec.)

Elemental analysis C₁₂H₁₂NO₃P (M: 249.20 g/mol):

calcd. C, 57.83%; H, 4.85%; N, 5.62%; P, 12.43%

found C, 57.5%; H, 5.1%; N, 5.5%; P, 12.4%

### Example 2

### Preparation of 9,10-dihydro-10-hydroxy-9-oxa-10-phosphaphenanthrene-10-one or -10-oxide ammonium salt (DOPO-ONH₄): solid procedure

232.0 g of dried and ground DOPO-OH with a particle size of <45 μm were provided in a closed grinding chamber and slowly reacted with 78.3 g of ammonia, 25% in water, while the shearing device was running. When the addition of ammonia was completed, the grinding material had heated to 77° C. without losing its powdered state. After 5 min of after-mixing, the shearing device was turned off, and the grinding material was left to rest for 1 h. Then, the material being mixed was reground for 5 min and emptied onto a drying tray, distributed and dried at 140° C. The yield was 242 g [97.2% of theory] of a white crystalline solid, the data of which essentially corresponded to those in Example 1.

### Example 3

### Preparation of 9,10-dihydro-10-hydroxy-9-oxa-10-phosphaphenanthrene-10-one or -10-oxide melaminium salt (DOPO-OMel)

In a multi-necked flask, equipped with a stirrer, a condenser and a thermometer, 92.8 g of DOPO-OH were suspended in 400 g of water and reacted with 50.4 g of melamine at 25° C. Subsequently, the suspension was heated to 90° C. and kept at this temperature for 4 h. Then, it was cooled to room temperature. The precipitate was filtered off and washed with water. Drying was done at 160° C., and the yield was 141.4 g [98.7% of theory] of a white crystalline solid.

Mp.: 246-250° C. (dec.)

Elemental analysis C₁₅H₁₅N₆O₃P (M: 358.29 g/mol):

calcd. C, 50.28%; H, 4.22%; N, 23.46%; P, 8.64%

found C, 49.8%; H, 4.5%; N, 23.3%; P, 8.5%

### Example 4

### Preparation of 9,10-dihydro-10-hydroxy-9-oxa-10-phosphaphenanthrene-10-one or -10-oxide guanidinium salt (DOPO-OGua)

In a multi-necked flask, equipped with a stirrer, a condenser and a thermometer, a mixture of 100.0 g of water, 100 g of ethanol and 36.0 g of guanidinium carbonate was prepared and heated to 75° C. Then, 92.8 g of DOPO-OH were added in portions over a period of 5.5 h. Once no further CO₂ development was detectable, the reaction mass was thickened by distillation. The remaining crude crystal paste (135.6 g) was applied onto a drying tray and dried at 110° C. The yield was 100.5 g [86.0% of theory] of a white crystalline solid.

Mp.: 278-280° C. (dec.)

Elemental analysis C₁₃H₁₄N₃O₃P (M: 291.24 g/mol):

calcd. C, 53.61%; H, 4.84%; N: 14.42%; P, 10.63%

found C, 53.3%; H, 5.1%; N, 14.3%; P, 10.5%

### Comparative Examples 1 to 16 and Examples 5 to 22

### Exemplary Application for the Endowment of Plastics with Flame Retardancy

For examining the afterflame time (in s) when flamed, specimens with 70×13×4 mm were produced from polystyrene and epoxide resin according to UL94. Shorter burning times thus mean better fire protection. For polyurethane specimens, the procedure was based on DIN 75200 or FMVSS 302.

### Comparative Examples 1 to 12 and Examples 5 to 15

### Preparation and Testing of Polystyrene Specimens Containing Flame Retardants

From granular polystyrene (M_{w}: approx. 192,000 g/mol, T_{g}: approx. 94° C.), specimens were formed as follows. The granulate was pulverized and mixed with the respective additives in a mortar (in Comparative Example 1 without any additives). 12 g each of the solids mixtures were weighed into aluminum dishes, which were then placed in a preheated drying cabinet and kept therein at the respectively required temperature until the powder had molten to give compact sheets. The required temperature depends on the composition of the respective mixture, and with the specimens tested it was between 180 and 195° C., and the melting process was completed after 12 to 15 min, as is shown in the following table. After cooling, the sheets were taken from the aluminum dishes and sawed up for the flame-retardancy tests.

As synergists, elemental sulfur, Vultac TB7, a p-t-butylphenoldisulfide polymer from the company Arkema, melamine thiosulfate (bis[(2,4,6-triamino-1,3,5-triazinium)thiosulfate; MelTS; produced by Krems Chemie Chemical Services AG as described in the co-pending Austrian patent application AT A . . . /2011) and ammonium thiosulfate ((NH₄)₂S₂O₃; ATS) were used.

The results obtained for the specimens are listed in the following Table 1 and are average values of four measurements.

TABLE 1
Polystyrene specimens

| | | | | | Polystyrene | Processing | Burning time, |
|---|---|---|---|---|---|---|---|
| Example | Flame retardant | wt % | Synergist | wt % | wt % | conditions | s |
| Comp. 1 | — | — | — | — | 100.0 | 190° C., 15 min | n.s. |
| Comp. 2 | DOPO | 5.0 | — | — | 95.0 | 180° C., 12 min | n.s. |
| Comp. 3 | DOPO | 10.0 | — | — | 90.0 | 180° C., 12 min | 24 |
| Comp. 4 | DOPO | 5.0 | ATS | 5.0 | 90.0 | 190° C., 15 min | 19 |
| Comp. 5 | DOPO-OH | 5.0 | — | — | 95.0 | 180° C., 12 min | n.s. |
| Comp. 6 | DOPO-OH | 3.0 | sulfur | 2.5 | 94.5 | 190° C., 15 min | 3 |
| Comp. 7 | DOPO-OH | 2.5 | Vultac TB7 | 4.0 | 93.5 | 190° C., 15 min | 5 |
| Comp. 8 | DOPO-OH | 5.0 | ATS | 5.0 | 90.0 | 190° C., 15 min | 15 |
| Comp. 9 | — | — | sulfur | 5.0 | 95.0 | 190° C., 15 min | 40 |
| Comp. 10 | — | — | Vultac TB7 | 5.0 | 95.0 | 180° C., 15 min | n.s. |
| Comp. 11 | — | — | MelTS | 8.0 | 92.0 | 180° C., 15 min | n.s. |
| Comp. 12 | — | — | ATS | 4.0 | 96.0 | 180° C., 15 min | n.s. |
| Example 5 | DOPO-ONH₄ | 8.0 | — | — | 92.0 | 190° C., 15 min | 12 |
| Example 6 | DOPO-ONH₄ | 2.5 | sulfur | 3.0 | 94.5 | 190° C., 15 min | 4 |
| Example 7 | DOPO-ONH₄ | 2.5 | Vultac TB7 | 4.0 | 93.5 | 190° C., 15 min | 5 |
| Example 8 | DOPO-ONH₄ | 8.0 | MelTS | 7.7 | 84.3 | 190° C., 15 min | 5 |
| Example 9 | DOPO-ONH₄ | 4.0 | ATS | 6.0 | 90.0 | 190° C., 15 min | 10 |
| Example 10 | DOPO-OMel | 8.0 | — | — | 92.0 | 190° C., 15 min | 19 |
| Example 11 | DOPO-OMel | 3.0 | Vultac TB7 | 4.0 | 93.0 | 190° C., 15 min | 5 |
| Example 12 | DOPO-OMel | 5.0 | MelTS | 7.0 | 88.0 | 190° C., 15 min | 7 |
| Example 13 | DOPO-OMel | 5.0 | ATS | 5.0 | 90.0 | 190° C., 15 min | 10 |
| Example 14 | DOPO-OGua | 8.0 | — | — | 92.0 | 190° C., 15 min | 15 |
| Example 15 | DOPO-OGua | 3.0 | Vultac TB7 | 4.0 | 93.0 | 190° C., 15 min | 5 |

n.s.: not self-extinguishing

### Comparative Examples 13 to 16 and Examples 16 and 17

### Preparation and Testing of Epoxide Resin Specimens Containing Flame Retardants

### Examples 16 and 17

### Incorporation Method

The novel compound of the invention, DOPO-O-MEL, ground in a mortar, and the epoxide resin DOW DEN 438 (epoxidized novolak) were stirred in a laboratory dissolver (DISPERMAT type; VMA-Getzmann GmbH) for 20 min under vacuum at 80° C. and 6000 rpm. Then, 6% of dicyandiamide (Dyhard 100S) and 2% of curing accelerator Fenuron (Dynhard UR 300) were added, and stirring was continued for further 5 min.

Subsequently, the mixture was poured into an aluminum dish and cured for 1 h at 110° C. and then for another hour at 130° C., followed by after-curing for 2 h at 200° C. Then, the sheets with a thickness of approx. 3 mm were slowly cooled and sawed into specimens according to DIN norm IEC 60695-11-10.

### Comparative Examples 13 to 16

### Pre-Formulation with DOPO

An epoxy novolak, D.E.N. 438 from Dow Chemicals with an EEW (epoxy equivalent weight) of 179 g/mol, was mixed with 0.1 wt % of triethanolamine and DOPO—in the amount necessary for adjusting the respectively required phosphorus content in the specimens (Comparative Example 13 did not contain any DOPO). The mixture was then kept at 140° C. for 2 h, degassed under vacuum, and cooled to 90° C. The pre-formulation thus produced was mixed at 90° C. with 6 parts by weight of dicyandiamide and 2 parts by weight of Fenuron, based on 100 parts by weight of epoxy novolak. Curing took place in an aluminum dish by gently heating to 120° C. over 30 min, keeping the temperature for 1 h, increasing the temperature to 130° C. for 1 h, and then keeping a temperature of 200° C. for 2 h. Therefrom, specimens of 70×13×4 mm were formed and classified for characterizing the burning properties according to UL94.

The results obtained for the specimens are shown in the following Table 2 and are average values of four measurements each.

TABLE 2
Epoxy resin specimens

| | | | Epoxy | | |
|---|---|---|---|---|---|
| Example | Flame retardant | wt % | wt % | Burning time, s | Odor |
| Comp. 13 | — | — | 100.0 | n.s. | — |
| Comp. 14 | DOPO | 5.0 | 95.0 | n.s. | — |
| Comp. 15 | DOPO | 10.0 | 90.0 | 10 | — |
| Comp. 16 | DOPO | 15.0 | 85.0 | 5 | — |
| Example 16 | DOPO-OMeI | 5.0 | 95.0 | 4 | — |
| Example 17 | DOPO-OMeI | 10.0 | 90.0 | 3 | — |

n.s.: not self-extinguishing

### Example 18

### Preparation and Testing of Polyurethane Resin Specimens Containing Flame Retardants

In a stirred vessel with a dissolver agitator, 195.75 g of a standard propylene oxide-ethyleneoxide-polyether triol with an OH number of 48±2 and a viscosity of 600-700 mPa·s were provided, and 23.49 g of DOPO-OMel were dispersed therein, until the particle size was <30 μm. Subsequently, 5.88 g of distilled water, 0.257 g of 1,4-diazabicyclo[2.2.2]octane, 0.312 g of N,N-dimethyl benzylamine, 0.99 g of polyethersiloxane (Tegostab BF 2370; Goldschmidt) and 0.585 of tin(II) 2-ethylhexanoate were added to the suspension in this order while the agitator was running. To this mixture, 71.25 g of Desmodur T 80 (Bayer Material Science) were added and thoroughly agitated. Then, the reaction mixture was emptied into a cardboard box for forming slab-stock foam. The mass fraction of DOPO-OMel in the formulation was 7.8%.

After 24 h, 6 specimens were cut from the slab-stock foam (density approx. 32 g/l) according to DIN 75200 or FMVSS 302 (16 to 20 mm), and their flammability was determined according to the same norm in a standard combustion chamber.

| Specimen | 1 | 2 | 3 | 4 | 5 | 6 |
|---|---|---|---|---|---|---|
| | 16 mm | 19 mm | 17 mm | 16 mm | 20 mm | 18 mm |

The test results according to the FMVSS 302 evaluation scheme were always: SE, i.e. “self-extinguishing.”

### Discussion of the Results

The results when using polystyrene as plastic mass show that all three novel salts of the present invention are very good flame retardants with clearly better effects than the comparative substances DOPO and DOPO-OH, the synthesis starting product. Their effectiveness can even be significantly enhanced by adding minor amounts of a synergist. The DOPO-OMel melaminium salt led to the least favorable results in this test—also because of its comparatively higher molecular weight, however, in a test with epoxy resin it was superior to DOPO. Furthermore, this and the subsequent test with polyurethane resin prove the versatility of this substance.

The novel compounds of the present invention are thus very well suited as flame retardants—alone and especially in combination with sulfur or sulfur-containing substances as synergists.

1. An ammonium salt of 9,10-dihydro-10-hydroxy-9-oxa-10-phosphaphenanthrene-10-one of formula I: 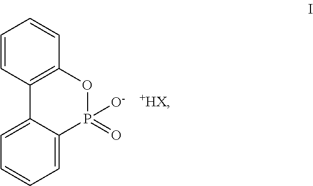
or
a ring-opened hydrolyzate thereof according to formula II: 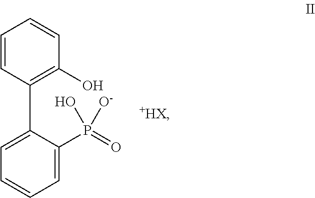
wherein X is selected from ammonia, melamine, and guanidine.

2. An ammonium salt according to claim 1, 10-dihydro-10-hydroxy-9-oxa-10-phosphaphenanthrene-10-one ammonium salt, having the formula:

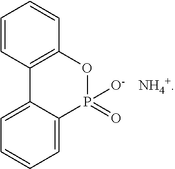

3. An ammonium salt according to claim 1, 9,10-dihydro-10-hydroxy-9-oxa-10-phosphaphenanthrene-10-one melaminium salt, having the formula:

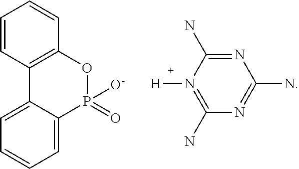

4. An ammonium salt according to claim 1, 9,10-dihydro-10-hydroxy-9-oxa-10-phosphaphenanthrene-10-one guanidinium salt, having the formula:

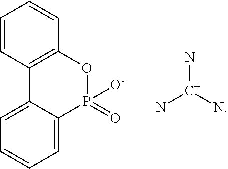

5. A flame-retardant composition comprising a substrate to be flame-protected and one or more ammonium salts according to claim 1 as (a) flame retardant(s).

6. The flame-retardant composition according to claim 5, wherein the ammonium salt or mixture thereof is present in the composition in the range of from 0.1 to 30 wt % based on the total weight of the substrate and the flame retardants.

7. The flame-retardant composition according to claim 6, wherein the ammonium salt or mixture thereof is present in the composition in the range of from 3 to 10 wt % based on the total weight of the substrate and the flame retardants.

8. The flame-retardant composition according to claim 5 further comprising elemental sulfur and/or at least one sulfur-containing compound.

9. The flame-retardant composition according to claim 8, wherein the at least one sulfur-containing compound has at least one S—S bond.

10. The flame-retardant composition according to claim 8 wherein the at least one sulfur-containing compound is selected from ammonium thiosulfate, melamine thiosulfate and alkylphenol polysulfides.

11. The flame-retardant composition according to claim 10 wherein the alkylphenol polysulfide is polymeric p-t-butylphenol disulfide.

12. The flame-retardant composition according to claim 5 further comprising one or more additives selected from organic peroxides, metals and metal compounds, nitrogen compounds, nanoparticles and mixtures thereof.

13. A method for preparing an ammonium salt according to claim 1 comprising reacting 9,10-dihydro-10-hydroxy-9-oxa-10-phosphaphenanthrene-10-one with ammonia, melamine or guanidine, or a salt thereof.

14. The method according to claim 13, wherein 9,10-dihydro-10-hydroxy-9-oxa-10-phosphaphenanthrene-10-one is reacted with ammonia to give 9,10-dihydro-10-hydroxy-9-oxa-10-phosphaphenanthrene-10-one ammonium salt.

15. The method according to claim 13, wherein 9,10-dihydro-10-hydroxy-9-oxa-10-phosphaphenanthrene-10-one is reacted with melamine to give 9,10-dihydro-10-hydroxy-9-oxa-10-phosphaphenanthrene-10-one melaminium salt.

16. The method according to claim 13, wherein 9,10-dihydro-10-hydroxy-9-oxa-10-phosphaphenanthrene-10-one is reacted with guanidinium carbonate to give 9,10-dihydro-10-hydroxy-9-oxa-10-phosphaphenanthrene-10-one guanidinium salt.
